(19) United States
(12) Patent Application Publication
(10) Pub. No.: US 2026/0202083 A1
(43) Pub. Date: Jul. 16, 2026

(54) OUTDOOR UNIT OF AIR CONDITIONING SYSTEM AND METHOD OF CONTROLLING OUTDOOR UNIT

(71) Applicants: SK Innovation Co., Ltd., Seoul (KR); SK Enmove Co., Ltd., Seoul (KR)

(72) Inventors: GIHONG MIN, Daejeon (KR); INSIK JUNG, Daejeon (KR)

(21) Appl. No.: 19/449,291

(22) Filed: Jan. 14, 2026

(30) Foreign Application Priority Data
Jan. 14, 2025 (KR) 10-2025-0005450

(51) Int. Cl. F24F 11/83

(52) U.S. Cl. CPC F24F 11/83

(57) ABSTRACT

An outdoor unit included in an air conditioning system may include a spraying module configured to spray liquid toward at least one of an outer surface and an inner surface of the outdoor unit to clean at least one of the outer surface and the inner surface of the outdoor unit.

### CROSS-REFERENCE TO RELATED PATENT APPLICATION

This patent application claims the benefit of Korean Patent Application No. 10-2025-0005450, filed on January 14, 2025, the disclosure of which is incorporated herein in its entirety by reference.

### TECHNICAL FIELD

The embodiments of the present disclosure relate generally to an air conditioning system capable of eliminating dust and waste accumulated on an outdoor unit while repelling animals contaminating the outdoor unit.

### BACKGROUND

An air conditioner is a device that controls air temperature, humidity, and cleanliness to provide a fresh indoor environment. The air conditioner operates based on a cooling cycle that involves absorption and release of heat as a refrigerant circulates through a compressor, condenser, expansion valve, and evaporator. The compressor and condenser may be included in an outdoor unit that is placed outside a building.

The outdoor unit may include a condenser efficiently releasing a large amount of heat, a compressor compressing the refrigerant to a high temperature and high pressure state to be delivered to the condenser, a fan facilitating heat release by forcing air through the condenser by convection, a pipe delivering heat between the compressor, condenser, and evaporator as the refrigerant circulates, and a case protecting internal components from the external environment.

### SUMMARY

The embodiments of the present disclosure are directed to providing an outdoor unit capable of cleaning an exterior or interior of an outdoor unit and a method of controlling the outdoor unit.

In addition, the embodiments of the present disclosure are directed to providing an outdoor unit capable of removing animal waste accumulated on an outdoor unit and a method of controlling the outdoor unit.

In addition, the embodiments of the present disclosure are directed to providing an outdoor unit capable of repelling animals that are likely to approach or inhabit the outdoor unit, and a method of controlling the outdoor unit.

In addition, the embodiments of the present disclosure are directed to providing an outdoor unit capable of reducing degradation in a cooling efficiency of an air conditioning system by removing waste accumulated on the outdoor unit, and a method of controlling the outdoor unit.

In addition, the embodiments of the present disclosure are directed to providing an outdoor unit capable of reducing electricity charges and noise generation by maintaining the performance of the outdoor unit, and a method of controlling the outdoor unit.

An outdoor unit included in an air conditioning system according to one embodiment of the present disclosure set forth herein may include a spraying module configured to spray liquid toward at least one of an outer surface and an inner surface of the outdoor unit to clean at least one of the outer surface and the inner surface of the outdoor unit.

In addition, the spraying module may be configured to receive a condensate generated by an evaporator included in the outdoor unit; and spray the condensate toward at least one of the outer surface and the inner surface of the outdoor unit to clean at least one of the outer surface and the inner surface of the outdoor unit.

In addition, the outdoor unit may further include a condensate storage tank configured to store the condensate received from the evaporator; and a condensate flow path connected between the condensate storage tank and the spraying module and configured to deliver the condensate stored in the condensate storage tank to the spraying module.

In addition, the outdoor unit may further include a processor configured to control the spraying module to periodically spray the condensate toward at least one of the outer surface and the inner surface of the outdoor unit in accordance with a preset time cycle.

In addition, the processor may be configured to control the spraying module to stop spraying the condensate when the air conditioning system including the outdoor unit receives a cooling command to cool an indoor space while the spraying module is spraying the condensate.

In addition, the spraying module may include at least one of a first spraying module and a second spraying module, the first spraying module may be configured to spray the condensate toward the outer surface of the outdoor unit to clean the outer surface of the outdoor unit, and the second spraying module may be configured to spray the condensate toward the inner surface of the outdoor unit to clean the inner surface of the outdoor unit.

In addition, the outdoor unit may further include at least one brush module configured to wipe at least one of the outer surface and the inner surface of the outdoor unit while traveling in contact with at least one of the outer surface and the inner surface of the outdoor unit.

In addition, the brush module may include a first brush module configured to wipe the outer surface of the outdoor unit while traveling in contact with the outer surface of the outdoor unit, and the first brush module may be configured to wipe the outer surface of the outdoor unit to which the condensate is adhered when the spraying module sprays the condensate toward the outer surface of the outdoor unit.

In addition, the brush module may include a second brush module configured to wipe the inner surface of the outdoor unit while traveling in contact with the inner surface of the outdoor unit, and the second brush module may be configured to wipe the inner surface of the outdoor unit to which the condensate is adhered when the spraying module sprays the condensate toward the inner surface of the outdoor unit.

In addition, the outdoor unit may further include a processor configured to control at least one brush module to periodically wipe at least one of the outer surface and the inner surface of the outdoor unit in accordance with a preset time cycle.

In addition, the processor may be configured to control the brush module to stop an operation of the brush module when the air conditioning system including the outdoor unit receives a cooling command to cool the indoor space while the brush module is wiping at least one of the outer surface and the inner surface of the outdoor unit.

In addition, the outdoor unit may further include a sensor module configured to detect whether an animal is present in an animal detection area for the outdoor unit; and a processor configured to control the spraying module and the brush module to drive at least one of the spraying module and the brush module when an animal is present in the animal detection area.

In addition, the outdoor unit may further include an animal repellent solution storage tank configured to mix a condensate received from the evaporator with an animal repellent substance to generate an animal repellent solution and store the generated animal repellent solution; and a repellent solution flow path connected between the solution storage tank and the spraying module and configured to deliver the animal repellent solution stored in the solution storage tank to the spraying module, wherein the spraying module may be configured to spray the animal repellent solution received from the animal repellent solution storage tank toward at least one of the outer surface and the inner surface of the outdoor unit.

In addition, the outdoor unit may further include a speaker module configured to emit an animal repellent sound having one frequency of a first frequency and a second frequency, wherein the processor may be configured to control the speaker module to emit the animal repellent sound when an animal is present in the animal detection area.

In addition, the sensor module may include a camera configured to detect whether an animal is present in the animal detection area for the outdoor unit by photographing the animal detection area to acquire an external image of the outdoor unit, and the processor may be configured to: determine an output frequency using an artificial intelligence model based on the external image of the outdoor unit when an animal is present in the animal detection area; and control the speaker module to emit the animal repellent sound at the output frequency.

In addition, the outdoor unit may further include a machine learning module configured to train the artificial intelligence model through a machine learning method by setting an external image of the outdoor unit for training that includes an animal image for training as an input variable and setting an output frequency for training corresponding to the animal for training as an output variable.

In addition, the outdoor unit may further include a spare fan module including at least one fan configured to repel an animal present in the animal detection area by discharging air inside the outdoor unit to the outside, and the processor may be configured to control the spare fan module to discharge the air inside the outdoor unit to the outside when an animal is present in the animal detection area.

A method of controlling an outdoor unit for controlling the outdoor unit according to one embodiment of the present disclosure set forth herein, wherein the method may include controlling, by a processor, the spraying module to periodically spray the condensate toward at least one of the outer surface and the inner surface of the outdoor unit in accordance with a preset time cycle; and controlling, by the processor, the at least one brush module to periodically wipe at least one of the outer surface and the inner surface of the outdoor unit in accordance with a preset time cycle.

In addition, the method may further include controlling, by the processor, the spraying module to stop spraying the condensate when the air conditioning system including the outdoor unit receives a cooling command to cool the indoor space while the spraying module is spraying the condensate; and controlling, by the processor, the brush module to stop an operation of the brush module when the air conditioning system including the outdoor unit receives a cooling command to cool the indoor space while the brush module is wiping at least one of the outer surface and the inner surface of the outdoor unit.

In addition, the method may further include detecting, by a sensor module, whether an animal is present in an animal detection area for the outdoor unit; and controlling, by the processor, the spraying module and the brush module to drive at least one of the spraying module and the brush module when an animal is present in the animal detection area.

According to one embodiment of the present disclosure set forth herein, it is possible to clean an exterior or interior of the outdoor unit.

According to another embodiment of the present disclosure set forth herein, it is possible to eliminate animal waste accumulated on the outdoor unit.

According to still another embodiment of the present disclosure set forth herein, it is possible to repel animals that are likely to approach or inhabit the outdoor unit.

According to still another embodiment of the present disclosure set forth herein, it is possible to reduce degradation in a cooling efficiency of the air conditioning system by eliminating waste accumulated on the outdoor unit.

According to yet another embodiment of the present disclosure set forth herein, it is possible to reduce electricity charge and noise generation by maintaining performance of the outdoor unit.

### BRIEF DESCRIPTION OF THE DRAWINGS

FIG. 1 is a diagram showing an exterior appearance of an outdoor unit according to an embodiment of the present disclosure.

FIG. 2 is a diagram showing a configuration of an air conditioning system including an outdoor unit according to an embodiment of the present disclosure.

FIG. 3 is a diagram for describing an operation of a spraying module and a brush module disposed on an outer surface of an outdoor unit according to an embodiment of the present disclosure.

FIG. 4 is a diagram for describing an operation of a spraying module and a brush module disposed on an inner surface of an outdoor unit according to an embodiment of the present disclosure.

FIG. 5 is a control block diagram of an outdoor unit according to an embodiment of the present disclosure.

FIG. 6 is a diagram showing an air conditioning system including an outdoor unit that uses an animal repellent solution according to an embodiment of the present disclosure.

FIG. 7 is a diagram for describing an operation of an outdoor unit when an animal is detected according to an embodiment of the present disclosure.

FIG. 8 is a flowchart of a method of controlling an outdoor unit according to an embodiment of the present disclosure.

FIG. 9 is a flowchart of a method of controlling an outdoor unit when an animal is detected according to an embodiment of the present disclosure.

### DETAILED DESCRIPTION OF THE EMBODIMENTS

The same reference numerals refer to the same components throughout the specification. This specification does not describe all elements of the embodiments, and contents that are general in the technical field to which the disclosed embodiments belongs or that overlap between the embodiments are omitted.

As used herein, the term “module” refers to a unit that processes at least one function or operation and may refer to, for example, software, a field-programmable gate array (FPGA), or a hardware component. The functions provided in the “module” may be performed separately by a plurality of components or may be integrated with other additional components. The “module” in this specification is not necessarily limited to software or hardware, and may be configured to reside on an addressable storage medium, and may be configured to boot one or more processors.

When a part of an embodiment is “connected” to another part, this includes not only a case of a direct connection, but also a case of an indirect connection in which still another part is present between the part and the another part.

In addition, when a part is said to “include” a component, this does not mean that it excludes other components, but rather that it may include other components, unless otherwise specifically described.

The terms “first”, “second”, etc. are used to distinguish one component from another, and the components are not limited by the aforementioned terms.

Singular expressions include plural expressions unless the context clearly indicates otherwise.

Reference numerals used for method operations are just used for convenience of description, but not to limit an order of the operations. Thus, unless the context clearly dictates otherwise, the written order may be practiced otherwise.

Hereinafter, the operating principle and embodiments of the present disclosure will be described with reference to the attached drawings.

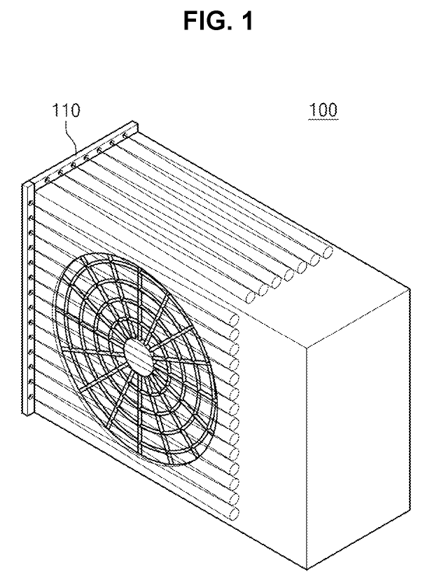

FIG. 1 is a diagram showing an exterior appearance of an outdoor unit according to an embodiment of the present disclosure.

Referring to FIG. 1, the outdoor unit 100 included in an air conditioning system 1 may include a spraying module 110.

The air conditioning system 1 may be an air handling system that performs indoor space cooling of a building. The air conditioning system 1 may be configured to perform cooling by circulation of a refrigerant. The refrigerant may be a conventional refrigerant such as chlorofluorocarbons (CFCs)—for example, CFC‑12 (dichlorodifluoromethane)—or hydrochlorofluorocarbons (HCFCs) such as HCFC‑22 (chlorodifluoromethane). Alternatively, the refrigerant may be a hydrofluorocarbon (HFC) such as HFC‑134a (1,1,1,2‑tetrafluoroethane). In addition, the refrigerant may be an environmentally friendly refrigerant such as R‑32 (difluoromethane) or R‑290 (propane), but the type of the first refrigerant is not limited thereto.

In this case, the refrigerant may absorb and release heat while circulating through the evaporator 300, the compressor 400, the condenser, and expansion valve 500 provided in the air conditioning system 1.

The refrigerant of which temperature has increased by passing through the evaporator 300 and the compressor 400 in sequence, may be delivered to the expansion valve 500 after its temperature has decreased in the condenser. The temperature of the refrigerant that is delivered to the evaporator 300 again while passing through the expansion valve 500 may decrease.

The outdoor unit 100 may include the condenser and the compressor 400 inside. It is understood that the compressor 400 may be provided separately as shown herein, regardless of the internal configuration of the outdoor unit 100.

Moreover, due to the outdoor unit 100 that is configured to release heat, wild animals avoiding the cold may stay and inhabit the surrounding area. In this case, if animals such as cats or pigeons approach or inhabit the outdoor unit 100, various adverse effects may occur.

Specifically, a heat exchanger in the outdoor unit 100 should release heat through the surrounding air. In this case, the outdoor unit 100 may draw air into the outdoor unit 100 through an air intake fan followed by cooling by releasing heat, and then discharge the air to the outside. In this case, when an animal lives on or near the outdoor unit 100, the air flow may be blocked, leading to deterioration of cooling efficiency or overheating. Accordingly, the power consumption of the air conditioning system 1 may increase, and the cooling performance may deteriorate. For example, when waste such as cat hair or pigeon feathers accumulates on the fan or heat exchanger, the fan may not rotate smoothly. As a result, the fan may be damaged and the motor may become overloaded, and thus the operation may be stopped.

In addition, when an animal scratches or bites pipes or wiring of the outdoor unit 100, a refrigerant leak or electrical system failure may occur. Birds such as pigeons may build nests and accumulate debris around pipes, causing leaks and corrosion of the pipe. Animal excrement (especially pigeon excrement) contains acidic components, such that accumulation of the excrement on the surface of the outdoor unit 100 or in the heat exchanger may cause corrosion and contamination and shorten the life of internal components.

In addition, when animals build nests and foreign substances such as branches or feathers accumulate inside the outdoor unit 100, overheating may cause a fire. In this case, electric sparks caused by damaged wiring may also increase the risk of fire, and damage to the wiring of the outdoor unit 100 or moisture from excrement may cause a current leak.

When an animal climbs on top of or enters the outdoor unit 100, rotation of the fan may be disturbed, or noise may be generated due to vibration. In this case, malfunction of the outdoor unit 100 and inconvenience in the living environment may increase.

When the outdoor unit 100 is damaged by animals, additional costs for repair or component replacement may be incurred, and costs for regular maintenance such as cleaning excrement and removing foreign substances may also increase.

Thus, it is necessary to periodically eliminate waste or dust generated by animals or accumulated on the outdoor unit 100 due to the weather, and to exterminate animals if they attempt to live near the outdoor unit 100.

The outdoor unit 100 may include a spraying module 110. The spraying module 110 may include at least one nozzle capable of spraying liquid, but the shape of the spraying module 110 is not limited thereto.

The spraying module 110 may spray liquid toward at least one of the outer surface and inner surface of the outdoor unit 100 to clean at least one of the outer surface and inner surface of the outdoor unit 100.

In this case, spraying of the liquid by the spraying module 110 enables elimination of waste accumulated on the outdoor unit 100 and provides an effect of repelling animals as animals loitering near the outdoor unit 100 move away to avoid the liquid.

Moreover, the spraying module 110 may be configured not to be connected to a separate pipe, but to store liquid to periodically spray the stored liquid, and have the liquid periodically resupplied by the user, but is not limited thereto. For example, the spraying module 110 may be connected to any pipe and continuously receive a spray liquid, such as water, from the pipe. When the water supplied to the spraying module 110 is supplied from tap water, it may incur unnecessary costs since purified water is wasted with a cost. Accordingly, it may be more preferable to utilize water that is inevitably generated depending on the characteristics of the air conditioning system 1.

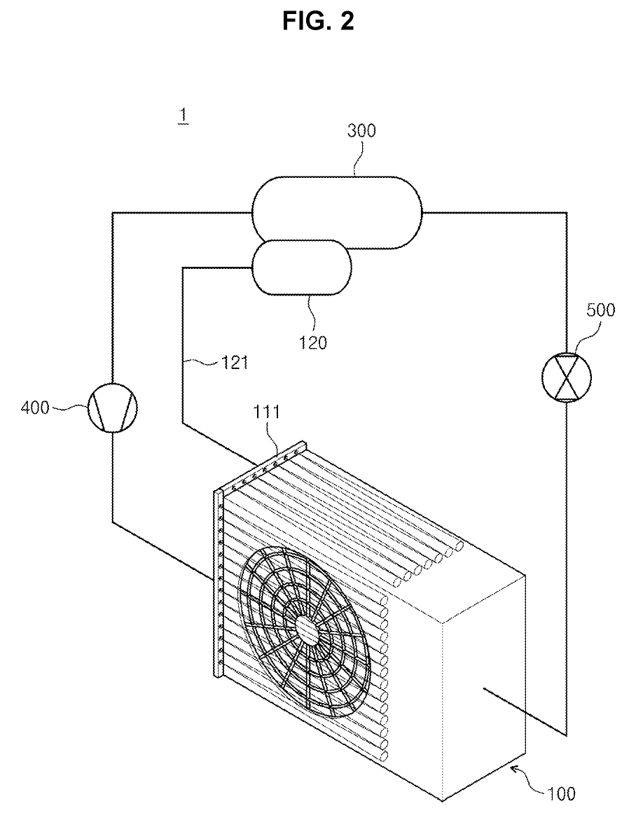

FIG. 2 is a diagram showing a configuration of the air conditioning system including an outdoor unit according to an embodiment of the present disclosure.

Referring to FIG. 2, the air conditioning system 1 may include the outdoor unit 100, evaporator 300, compressor 400, and expansion valve 500.

The outdoor unit 100 may include a spraying module 110 (111, 112), a condensate storage tank 120, condensate flow path 121, and brush module 130 (131, 132). The spraying module 110 (also referred to as spray module) includes a first spraying module 111 and a second spraying module 112. The brush module 130 includes a first brush module 131 and a second brush module 132.

The spraying module 110 may receive the condensate generated by the evaporator 300 included in the outdoor unit 100.

When cooling the indoor space, the air conditioning system 1 may condense water vapor in the air on the surface of the low-temperature evaporator 300 to convert the water vapor into a condensate, such as condensate water. This condensate may be collected separately to be stored in a container.

The spraying module 110 may clean at least one of the outer surface and the inner surface of the outdoor unit 100 by spraying the condensate toward at least one of the outer surface and the inner surface of the outdoor unit 100.

The condensate storage tank 120 may be a container that stores the condensate received from the evaporator 300. The condensate storage tank 120 may deliver the condensate to the condensate flow path 121.

The condensate flow path 121 may be connected between the condensate storage tank 120 and the spraying module 110. The condensate flow path 121 may deliver the condensate stored in the condensate storage tank 120 to the spraying module 110.

The outdoor unit 100 according to one embodiment may perform cleaning and animal repelling solely with the spraying module 110, but additionally perform cleaning and animal repelling by driving a brush, such as a vehicle wiper. In addition, the liquid injection and brush operation may be driven for the external surface of the outdoor unit 100 or for the internal surface.

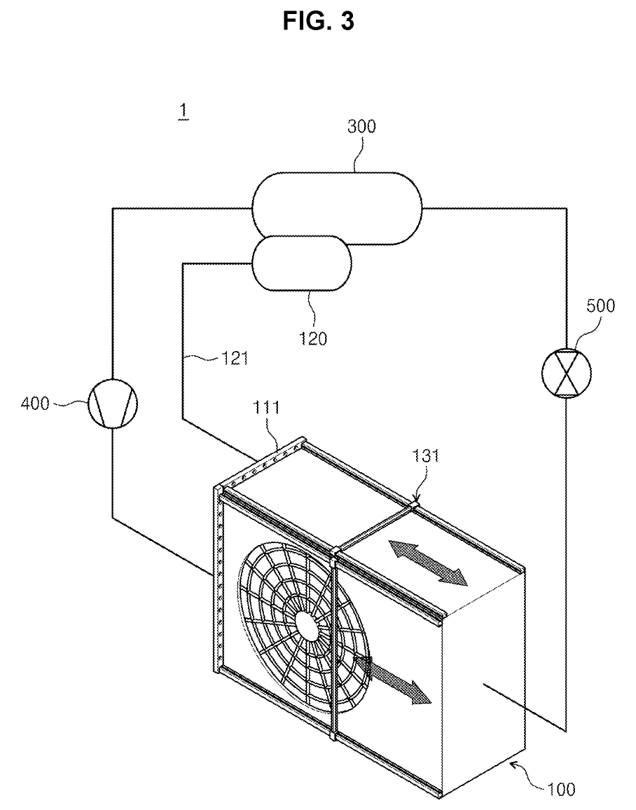

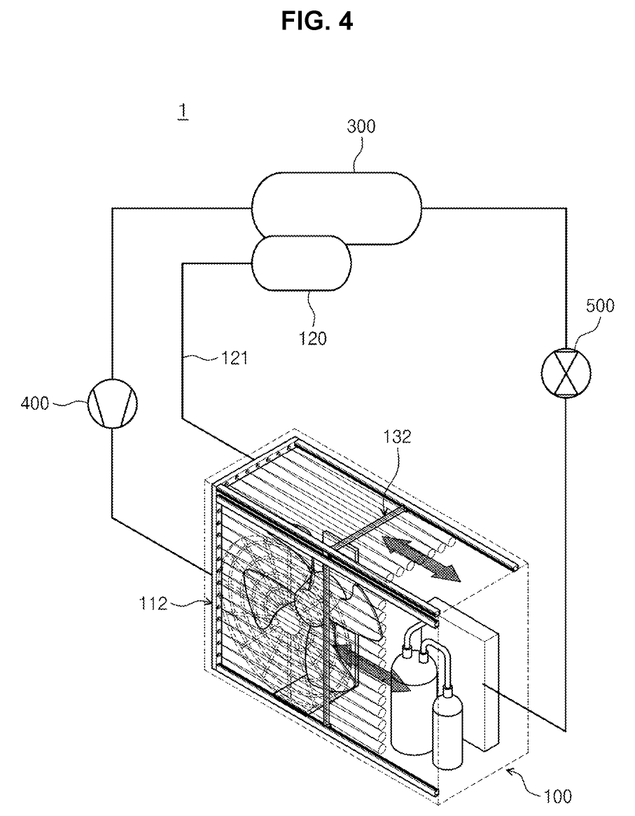

FIG. 3 is a diagram for describing an operation of the spraying module and the brush module disposed on the outer surface of the outdoor unit according to an embodiment of the present disclosure, and FIG. 4 is a diagram for describing an operation of the spraying module and the brush module disposed on the inner surface of the outdoor unit according to an embodiment of the present disclosure.

Referring to FIGS. 3 and 4, the spraying module 110 may include at least one of the first spraying module 111 and the second spraying module 112.

The first spraying module 111 may spray the condensate toward the outer surface of the outdoor unit 100 to clean the outer surface of the outdoor unit 100.

The second spraying module 112 may spray the condensate toward the inner surface of the outdoor unit 100 to clean the inner surface of the outdoor unit 100.

The spraying module 110 may also include at least one brush module 130. The brush module 130 may be configured to wipe at least one of the outer surface and the inner surface of the outdoor unit 100 while traveling in contact with at least one of the outer surface and the inner surface of the outdoor unit 100.

The brush module 130 may wipe the surface of the outdoor unit 100 by itself, and may also perform cleaning by spreading the condensate that has already been sprayed. In addition, the brush module 130 may repel animals by causing the animal near the outdoor unit 100 to run away when they feel threatened or make direct physical contact.

Each brush module 130 may include a motor that provides driving force, a brush cleaning the surface of the outdoor unit 100, and a plurality of rails guiding the brush to move along, but the configuration or shape of the brush module 130 is not limited thereto. For example, the brush module 130 may be driven in a manner in which the brush rotates around a single axis, like a vehicle wiper.

The brush module 130 may include at least one of the first brush module 131 and the second brush module 132.

The first brush module 131 may be configured to wipe the outer surface of the outdoor unit 100 while traveling in contact with the outer surface of the outdoor unit 100. When the spraying module 110 sprays the condensate toward the outer surface of the outdoor unit 100, the first brush module 131 may be configured to wipe the outer surface of the outdoor unit 100 to which the condensate is adhered.

The second brush module 132 may be configured to wipe the inner surface of the outdoor unit 100 while traveling in contact with the inner surface of the outdoor unit 100. The second brush module 132 may be configured to wipe the inner surface of the outdoor unit 100 to which the condensate is adhered when the spraying module 110 sprays the condensate toward the inner surface of the outdoor unit 100.

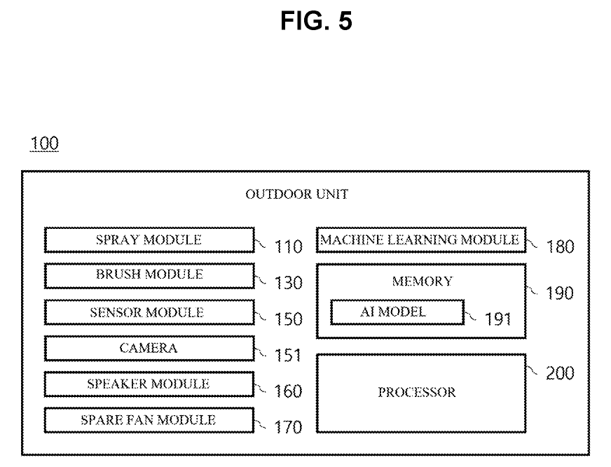

FIG. 5 is a control block diagram of the outdoor unit according to an embodiment of the present disclosure.

Referring to FIG. 5, the outdoor unit 100 may include a sensor module 150, camera 151, speaker module 160, spare fan module 170, machine learning module 180, memory 190, and processor 200.

The processor 200 may control the spraying module 110 to periodically spray the condensate toward at least one of the outer surface and the inner surface of the outdoor unit 100 in accordance with a preset time cycle. For example, the spraying module 110 may periodically spray the condensate toward at least one of the outer surface and the inner surface of the outdoor unit 100 every two hours, which may be a preset cycle.

The processor 200 may control at least one brush module 130 to periodically wipe at least one of the outer surface and the inner surface of the outdoor unit 100 in accordance with a preset time cycle. For example, the brush module 130 may periodically wipe at least one of the outer surface and the inner surface of the outdoor unit 100 every three hours, which may be a preset cycle.

When a user wants indoor space cooling, the condenser and cooling fan of the outdoor unit 100 should be operated, in which case it may be preferable to stop the spraying of the condensate and operation of the brush module.

When the air conditioning system 1 including the outdoor unit 100 receives a cooling command to cool the indoor space through the input module or remote control while the spraying module 110 is spraying the condensate, the processor 200 may control the spraying module 110 to stop spraying the condensate.

When the air conditioning system 1 including the outdoor unit 100 receives the cooling command to cool the indoor space while the brush module 130 is wiping at least one of the outer surface and the inner surface of the outdoor unit 100, the processor 200 may control the brush module 130 to stop the operation of the brush module 130.

For repelling animals more effectively, instead of just spraying the condensate, it may be more effective to create and spray a solution mixed with specific ingredients that animals avoid, using the condensate.

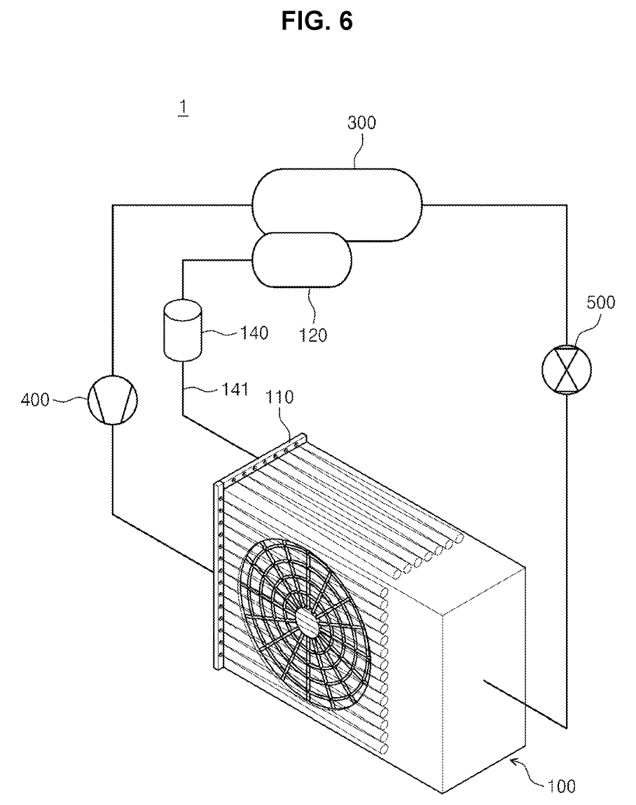

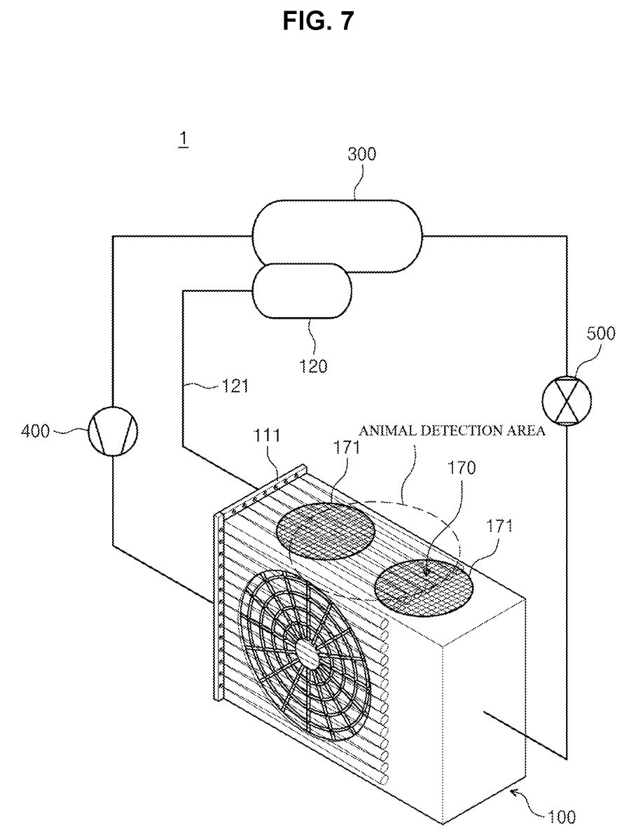

FIG. 6 is a diagram showing the air conditioning system including the outdoor unit using an animal repellent solution according to one embodiment of the present disclosure, and FIG. 7 is a diagram for describing an operation of the outdoor unit when an animal is detected according to an embodiment of the present disclosure.

Referring to FIGS. 5, 6, and 7, the sensor module 150 may detect whether an animal is present in the animal detection area for the outdoor unit 100. The sensor module 150 may transmit a signal indicating that the animal has been detected to the processor 200 upon detection of the animal.

The animal detection area may be, but is not limited to, the area near the top of the outdoor unit 100. For example, the animal detection area may be the side or inside of the outdoor unit 100.

The sensor module 150 may be, but is not limited to, any one of a passive infrared (PIR) sensor that detects animals based on their movements and body temperature (infrared emission), an ultrasonic sensor that detects ultrasonic reflection signals when animals such as pigeons or cats move or approach a specific area, a microwave sensor that detects animal movement patterns or presence in an area, a radar sensor, and a thermal imaging camera.

When an animal is present in the animal detection area, the processor 200 may control the spraying module 110 and the brush module 130 to drive at least one of the spraying module 110 and the brush module 130.

The outdoor unit 100 may include an animal repellent solution storage tank 140 and a repellent solution flow path 141.

The animal repellent solution storage tank 140 may generate an animal repellent solution by mixing the condensate received from the evaporator 300 with an animal repellent substance.

The animal repellent substance is made from natural ingredients, such as citrus oil, vinegar, capsaicin (component of chili peppers), and mint oil, or a specific synthetic odor as synthetic chemical ingredients, or artificially combined volatile irritants.

The animal repellent solution storage tank 140 may be a container configured to store the generated animal repellent solution. The animal repellent solution storage tank 140 may deliver the repellent solution to the animal repellent solution flow path 141.

The repellent solution flow path 141 may be connected between the solution storage tank and the spraying module 110. The repellent solution flow path 141 may be configured to deliver the animal repellent solution stored in the solution storage tank to the spraying module 110.

The spraying module 110 may spray the animal repellent solution received from the animal repellent solution storage tank 140 toward at least one of the outer surface and the inner surface of the outdoor unit 100.

The outdoor unit 100 according to one embodiment may also repel animals using sound.

The speaker module 160 may emit an animal repellent sound having one frequency of a first frequency and a second frequency. The frequency between the first frequency and the second frequency may be in a frequency range that is beyond the audible frequency range for humans and thus inaudible, but is heard as noise by animals which are the target.

When an animal is present in the animal detection area, the processor 200 may control the speaker module 160 to emit the animal repellent sound.

Depending on the detected animal, it may be most effective to output a sound at a frequency that the animal would least like to hear.

The sensor module 150 may include the camera 151. As a camera sensor, the camera 151 may detect whether an animal is present in the animal detection area for the outdoor unit 100 by photographing the animal detection area to capture an external image of the outdoor unit 100.

The method of determining the frequency to be output for the detected animal may be according to a preset algorithm, but may also be using an artificial intelligence model 191 that is pre-trained through a machine learning method.

Machine learning may refer to using a model composed of a plurality of parameters and optimizing the parameters based on given data. Depending on the type of learning materials, machine learning may include supervised learning, unsupervised learning, and reinforcement learning. Supervised learning refers to learning of a mapping between inputs and outputs and is applicable when input-output pairs are given as data. Unsupervised learning is applied when there are only inputs with no outputs and may identify patterns between inputs.

The machine learning module 180 may generate or train the artificial intelligence model 191 in various ways. For example, the machine learning module 180 may learn features extracted from training data using a deep learning-based learning method.

In this case, in order to learn a method of extracting features from the learning data, a convolutional neural network (CNN) structure with multiple stages of convolution layers stacked may be utilized, but the learning method of the machine learning module 180 is not necessarily limited to a method that utilizes the CNN structure. For example, the learning method of the machine learning module 180 may be a method that involves machine learning algorithms including artificial neural network (ANN) or recurrent neural network (RNN).

The processor 200 may determine the output frequency using an artificial intelligence model 191 based on the external image of the outdoor unit when an animal is present in the animal detection area. The artificial intelligence model 191 may be stored in the memory 190 as a pre-trained model.

The processor 200 may control the speaker module 160 to emit an animal repellent sound at an output frequency.

The machine learning module 180 may train the artificial intelligence model 191 through the machine learning method by setting an external image of the outdoor unit for training that include an animal image for training as an input variable and setting an output frequency for training corresponding to the animal for training as an output variable.

Repelling animals may be accomplished by spraying liquid, driving the brush module 130, or generating wind in addition to emitting sound.

The outdoor unit 100 may be provided with a cooling fan that is driven to cool the condenser by introducing air inside.

The outdoor unit 100 according to one embodiment may be provided with a spare fan 171 that is provided separately from the cooling fan.

The spare fan module 170 may include at least one fan 171. Each fan 171 may be configured to repel animals present in the animal detection area by discharging air inside the outdoor unit 100 to the outside.

In addition to the animal repelling function, the spare fan module 170 also has the effect of increasing a cooling efficiency for the condenser by releasing the air inside the outdoor unit 100 that has been introduced through the cooling fan to facilitate air circulation.

When an animal is present in the animal detection area, the processor 200 may control the spare fan module 170 to discharge the air inside the outdoor unit 100 to the outside.

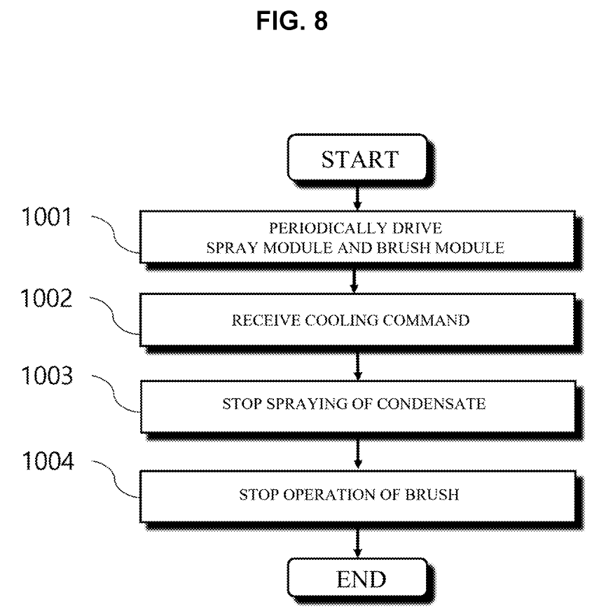

FIG. 8 is a flowchart of a method of controlling an outdoor unit according to an embodiment of the present disclosure. It is apparent that some configurations may be added or deleted as needed to the embodiments of the present disclosure.

Referring to FIG. 8, the processor 200 may control the spraying module 110 and the brush module 130 to be driven periodically in accordance with a preset time cycle (1001).

While the spraying module 110 sprays the condensate and the brush module 130 is in operation, the air conditioning system 1 including the outdoor unit 100 may receive a cooling command to cool the indoor space (1002).

When the air conditioning system 1 receives the cooling command, the processor 200 may control the spraying module 110 to stop spraying the condensate (1003).

When the air conditioning system 1 receives the cooling command, the processor 200 may control the brush module 130 to stop the operation of the brush module 130 (1004).

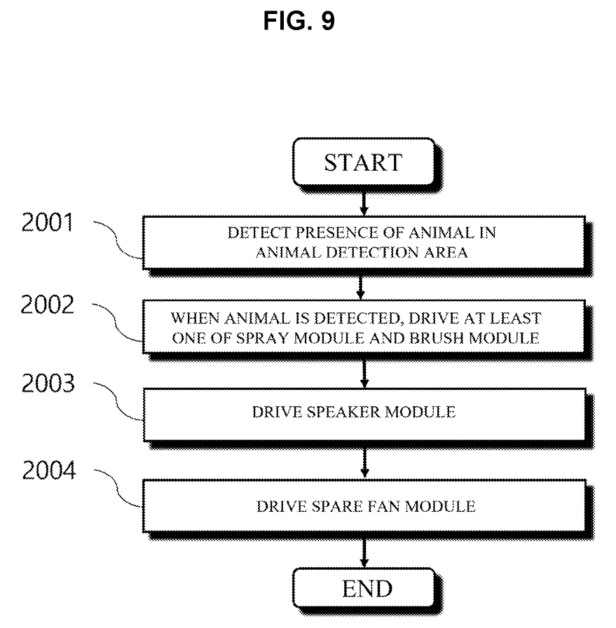

FIG. 9 is a flowchart of a method of controlling an outdoor unit when an animal is detected according to an embodiment of the present disclosure.

Referring to FIG. 9, the sensor module 150 may detect whether an animal is present in the animal detection area for the outdoor unit 100 (2001).

When an animal is present in the animal detection area, the processor 200 may control the spraying module 110 and the brush module 130 to drive at least one of the spraying module 110 and the brush module 130 (2002).

When an animal is present in the animal detection area, the processor 200 may control the speaker module 160 to emit an animal repellent sound having one frequency of the first frequency and the second frequency (2003).

When an animal is detected to be present within the animal detection area, the processor 200 may control the spare fan module 170 to discharge the air from the inside of the outdoor unit 100 to the outside (2004).

The spraying module 110, first spraying module 111, second spraying module 112, first brush module 131, second brush module 132, sensor module 150, camera 151, speaker module 160, spare fan module 170, and machine learning module 180 may include at least one processor 200 provided in the outdoor unit 100.

The method of controlling an outdoor unit 100 according to the embodiments of the present disclosure described above and those to be described later may be implemented in the form of a program executable by the processor 200.

The program may include program commands, data files, and data structures, either alone or in combination. The program may be designed and constructed using machine language codes or high-level language codes. The program may be specially designed to implement the method of controlling the outdoor unit 100 described above, or may be implemented using various functions or definitions that are already known and available to those skilled in the field of computer software. The program for implementing the above-described method of controlling the outdoor unit 100 may be recorded on a recording medium readable by the processor 200. In this case, the recording medium may be the memory 190.

The memory 190 may store a program that performs the operations described above and those to be described later, and the memory 190 may execute the stored program. In cases where the processor 200 and the memory 190 are provided in plural numbers, they may be integrated into a single chip or provided in physically separate locations. The memory 190 may include volatile memory such as Static Random Access Memory (S-RAM) and Dynamic Random Access Memory (D-RAM) for temporarily storing data. In addition, the memory 190 may include non-volatile memory such as Read Only Memory (ROM), Erasable Programmable Read Only Memory (EPROM), and Electrically Erasable Programmable Read Only Memory (EEPROM) for long-term storage of a control program and control data.

The processor 200 may include various logic circuits and arithmetic circuits, and may process data according to a program provided from the memory 190, and generate a control signal according to the processing result.

While the embodiments of the present disclosure have been described with reference to the illustrated embodiments, these are merely provide as illustrations, and it will be understood by those skilled in the art that various alterations, variations, and equivalent other embodiments may be made without departing from the gist and scope of the present disclosure. Therefore, the scope of the present disclosure should be defined by the technical concepts of the appended claims. Furthermore, the embodiments may be combined to form additional embodiments.

What is claimed is:

1. An outdoor unit included in an air conditioning system, comprising a spraying module configured to spray liquid toward at least one of an outer surface and an inner surface of the outdoor unit to clean the at least one of the outer surface and the inner surface of the outdoor unit.

2. The outdoor unit of claim 1, wherein the spraying module is configured to:
receive a condensate generated by an evaporator included in the outdoor unit; and
spray the condensate toward the at least one of the outer surface and the inner surface of the outdoor unit to clean the at least one of the outer surface and the inner surface of the outdoor unit.

3. The outdoor unit of claim 2, further comprising:
a condensate storage tank configured to store the condensate received from the evaporator; and
a condensate flow path connected between the condensate storage tank and the spraying module and configured to deliver the condensate stored in the condensate storage tank to the spraying module.

4. The outdoor unit of claim 3, further comprising a processor configured to control the spraying module to periodically spray the condensate toward the at least one of the outer surface and the inner surface of the outdoor unit in accordance with a preset time cycle.

5. The outdoor unit of claim 4, wherein the processor is configured to control the spraying module to stop spraying the condensate when the air conditioning system including the outdoor unit receives a cooling command to cool an indoor space while the spraying module is spraying the condensate.

6. The outdoor unit of claim 2, wherein the spraying module includes at least one of a first spraying module and a second spraying module,
wherein the first spraying module is configured to spray the condensate toward the outer surface of the outdoor unit to clean the outer surface of the outdoor unit, and
wherein the second spraying module is configured to spray the condensate toward the inner surface of the outdoor unit to clean the inner surface of the outdoor unit.

7. The outdoor unit of claim 2, further comprising at least one brush module configured to wipe at least one of the outer surface and the inner surface of the outdoor unit while traveling in contact with at least one of the outer surface and the inner surface of the outdoor unit.

8. The outdoor unit of claim 7, wherein the brush module includes a first brush module configured to wipe the outer surface of the outdoor unit while traveling in contact with the outer surface of the outdoor unit, and
wherein the first brush module is configured to wipe the outer surface of the outdoor unit to which the condensate is adhered when the spraying module sprays the condensate toward the outer surface of the outdoor unit.

9. The outdoor unit of claim 7, wherein the brush module includes a second brush module configured to wipe the inner surface of the outdoor unit while traveling in contact with the inner surface of the outdoor unit, and
wherein the second brush module is configured to wipe the inner surface of the outdoor unit to which the condensate is adhered when the spraying module sprays the condensate toward the inner surface of the outdoor unit.

10. The outdoor unit of claim 7, further comprising a processor configured to control at least one brush module to periodically wipe at least one of the outer surface and the inner surface of the outdoor unit in accordance with a preset time cycle.

11. The outdoor unit of claim 10, wherein the processor is configured to control the brush module to stop an operation of the brush module when the air conditioning system including the outdoor unit receives a cooling command to cool the indoor space while the brush module is wiping at least one of the outer surface and the inner surface of the outdoor unit.

12. The outdoor unit of claim 7, further comprising:
a sensor module configured to detect whether an animal is present in an animal detection area for the outdoor unit; and
a processor configured to control the spraying module and the brush module to drive at least one of the spraying module and the brush module when an animal is present in the animal detection area.

13. The outdoor unit of claim 12, further comprising:
an animal repellent solution storage tank configured to mix a condensate received from the evaporator with an animal repellent substance to generate an animal repellent solution and store the generated animal repellent solution; and
a repellent solution flow path connected between the solution storage tank and the spraying module and configured to deliver the animal repellent solution stored in the solution storage tank to the spraying module,
wherein the spraying module is configured to spray the animal repellent solution received from the animal repellent solution storage tank toward at least one of the outer surface and the inner surface of the outdoor unit.

14. The outdoor unit of claim 12, further comprising a speaker module configured to emit an animal repellent sound having one frequency of a first frequency and a second frequency,
wherein the processor is configured to control the speaker module to emit the animal repellent sound when an animal is present in the animal detection area.

15. The outdoor unit of claim 14, wherein the sensor module includes a camera configured to detect whether an animal is present in the animal detection area for the outdoor unit by photographing the animal detection area to acquire an external image of the outdoor unit, and
the processor is configured to:
determine an output frequency using an artificial intelligence model based on the external image of the outdoor unit when an animal is present in the animal detection area; and
control the speaker module to emit the animal repellent sound at the output frequency.

16. The outdoor unit of claim 15, further comprising a machine learning module configured to train the artificial intelligence model through a machine learning method by setting an external image of the outdoor unit for training that includes an animal image for training as an input variable and setting an output frequency for training corresponding to the animal for training as an output variable.

17. The outdoor unit of claim 12, further comprising a spare fan module including at least one fan configured to repel an animal present in the animal detection area by discharging air inside the outdoor unit to the outside, and
the processor is configured to control the spare fan module to discharge the air inside the outdoor unit to the outside when an animal is present in the animal detection area.

18. A method of controlling an outdoor unit for controlling the outdoor unit according to claim 7, the method comprising:
controlling, by a processor, the spraying module to periodically spray the condensate toward at least one of the outer surface and the inner surface of the outdoor unit in accordance with a preset time cycle; and
controlling, by the processor, the at least one brush module to periodically wipe at least one of the outer surface and the inner surface of the outdoor unit in accordance with a preset time cycle.

19. The method of claim 18, further comprising:
controlling, by the processor, the spraying module to stop spraying the condensate when the air conditioning system including the outdoor unit receives a cooling command to cool the indoor space while the spraying module is spraying the condensate; and
controlling, by the processor, the brush module to stop an operation of the brush module when the air conditioning system including the outdoor unit receives a cooling command to cool the indoor space while the brush module is wiping at least one of the outer surface and the inner surface of the outdoor unit.

20. The method of claim 18, further comprising:
detecting, by a sensor module, whether an animal is present in an animal detection area for the outdoor unit; and
controlling, by the processor, the spraying module and the brush module to drive at least one of the spraying module and the brush module when an animal is present in the animal detection area.

21. An outdoor unit for an air conditioning system, the outdoor unit comprising:
a housing defining an interior space and having an outer surface;
an outer spraying module mounted on the housing and configured to discharge a cleaning fluid on an external surface of the housing to remove contaminants from the external surface of the housing;
an inner spraying module mounted on the housing and configured to discharge a cleaning fluid on an internal surface of the housing to remove contaminants from the internal surface of the housing;
a sensor module configured to detect whether an animal is present within an animal detection area for the outdoor unit;
a speaker module configured to emit an animal repellent sound at a selected frequency; and
a processor configured to i) select the frequency for the repellent sound based on an artificial intelligence model and info received from the sensor module when an animal is present in the animal detection area, and ii) control the speaker module to emit the animal repellent sound at the selected frequency.
